(19) United States
(12) Patent Application Publication
(10) Pub. No.: US 2024/0210963 A1
(43) Pub. Date: Jun. 27, 2024

(54) FAILURE PREDICTION AND RISK MITIGATION IN SMALL UNCREWED AERIAL SYSTEMS

(71) Applicant: Inspired Flight Technologies, Inc., San Luis Obispo, CA (US)

(72) Inventors: Richard Stollmeyer, San Luis Obispo, CA (US); Kanaka Saripalli, Danville, CA (US); Marcus Stollmeyer, Oceano, CA (US)

(21) Appl. No.: 18/232,650

(22) Filed: Aug. 10, 2023

Related U.S. Application Data
(60) Provisional application No. 63/396,930, filed on Aug. 10, 2022.

(51) Int. Cl. G05D 1/85; G05D 1/654; G05D 101/15; G05D 109/20; G05D 111/30

(52) U.S. Cl. CPC G05D 1/857; G05D 1/6546; G05D 2101/15; G05D 2109/20; G05D 2111/30

(57) ABSTRACT

A computer-implemented system and associated method of operating a Small Uncrewed Aircraft System (SUAS) including at least one Small Uncrewed Aircraft or “drone.” The method comprises capturing data during operation of the SUAS from a number of sensors of different types, performing analysis on the captured data using one or more Artificial Intelligence/Machine Learning (AI/ML) models that have been trained on data sets including historical SUAS data and SUAS system fault data, to predict or identify a potential SUAS failure mode, and when a potential failure mode is predicted or identified, providing a course of action for further operation of the SUAS based on a severity and predicted timing of the SUAS failure mode.

### RELATED APPLICATION DATA

This application claims the benefit of U.S. Provisional Patent Application No. 63/396,930 filed on Aug. 10, 2022, the contents of which are incorporated herein by reference as if explicitly set forth.

### FIELD OF THE INVENTION

The technology relates to the general field of commercial-grade Small Uncrewed Aircraft (hereinafter referred to as “drones”), Small Uncrewed Aircraft Systems (SUASs) and Small Uncrewed Aircraft Fleets (SUAFs). The drone is a remotely or autonomously piloted aerial vehicle usually propelled electrically. The SUAS incorporates the drone, the payloads it carries, the ground-based systems that control and interface with it, the human or autonomous software that pilots it, and the communications signals between all of these elements. An SUAF is any collection of two or more SUASs managed, owned or operated by the same commercial or government entity. Disclosed herein are some examples of systems and methods that have application to the detection of failure precursors in any element of the SUAS, and proactive initiation of events to prevent or mitigate the impact of any resulting drone crash.

For the purposes of this application, SUASs are those that employ drones that meet the requirements of Federal Aviation Administration (FAA) classifications of: Group 1, those that weigh less than 20 lbs., and fly less than 1200 feet above ground level (AGL) and less than 100 knots; Group 2, those that weigh less than 55 lbs., and fly less than 3500 AGL and less than 250 knots; and Group 3, those that weigh less than 1320 lbs., fly less than <18,000 feet above mean sea level (MSL) and less than 250 knots. Presently, both the DOD and FAA require each untethered commercial drone in these categories to have a dedicated, licensed human drone pilot controlling the aircraft via a ground control station component. In the future, DOD or FAA regulations may evolve along with SUAS technology advancements to allow autonomous flight of SUAS with a single pilot simultaneously controlling multiple drones, or without direct human pilot control at all.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Referring now to the drawings, in which:

FIG. 1 illustrates a high-level view of a Small Uncrewed Aircraft System (SUAS), according to some examples.

FIG. 2 illustrates a high-level view of a Small Uncrewed Aircraft Fleet (SUAF), according to some examples.

FIG. 3 illustrates a system architecture for the SUAF of FIG. 2, as it relates to airframe and electrical propulsion system failure prediction, detection and mitigation, according to some examples.

FIG. 4 illustrates the fault prediction component and fault detection ensemble of FIG. 3 in more detail, according to some examples.

FIG. 5 illustrates a cloud-based data platform and AI/ML engine architecture, according to some examples.

FIG. 6 is a schematic diagram illustrating a training system architecture according to some examples.

FIG. 7 is a flowchart illustrating a method of implementing an airframe and electrical propulsion system failure prediction and mitigation system in an SUAS according to some examples.

FIG. 8 illustrates one example of a system architecture and data processing device that may be used to implement one or more illustrative aspects described herein in a standalone and/or networked environment.

### DETAILED DESCRIPTION

There are currently no additional legal mandates governing the operation of SUAFs, beyond the laws and regulations that apply to individual SUASs, however these organizations have a common interest in maximizing the reliability, cost efficiency, safety and return on investment of their drone fleets. The examples disclosed herein are designed to benefit both individual SUAS pilots as well as owners and operators of commercial and government SUAFs.

SUASs have myriad applications, in broad categories such as surveillance and assessment, aerial inspection and repair, logistics, rescue and package delivery. There is growing adoption of these SUAS applications by various government and commercial industries, including military & defense, agricultural services, firefighting, first responders, public safety, logistics & transportation, healthcare, construction & mining, utilities, renewable energy, and telecommunications.

Drones may use a combination of rotors and fixed wings to provide lift in a manner similar to traditional aircraft. In most cases the rotors are propelled by brushless direct current (BLDC) electrical motors that are controlled by electronic speed controllers (ESCs). BLDC motors are powered either by onboard batteries, electricity generating fuel-cells, or tethered cables connected to a land-based power source. Each of these components in a drone propulsion system—as well as the airframe and propellers that translate propulsion into flight—have multiple possible failure modes. These failure modes may be predicted and mitigated through the implementation of certain in-flight monitoring and detection systems, combined with the collection of the resulting data and analysis of such data with algorithmic and AI/ML software strategies, which are described herein.

possible configurations of electrically powered drones that will benefit from the examples disclosed herein include fixed-wing vertical takeoff and landing (VTOL) aircraft, which usually employ three to five electric motors; quadcopters, which have four electric motors; hexacopters, which have six electric motors; and octocopters, which have eight electric motors.

Regardless of drone configuration, SUAS mishaps are much more common than in general crewed aviation. The general aviation mishap rate is about 1 per 100,000 flight hours. There is little available aggregate data on SUAS mishaps, although the rates of such mishaps are generally known by those in the industry to be much higher. For example, even large military grade drones, which are equipped with sophisticated redundant systems similar to crewed commercial and military aircraft, are known to experience mishap rates of nearly 1 per 1000 flight hours, which is 2 orders of magnitude higher than in general aviation. The actual mishap rates of electrically propelled drones are likely multiple orders of magnitude higher than this.

A special category of SUAS mishaps are those failure modes that commonly lead to drone crashes, collectively referred to as Critical System Failure Modes (CSFMs). Possible SUAS CSFMs include: Pilot Error, Battery of Fuel Cell Failure, Power Distribution System Failure, Propulsion System Failure, Navigation Sensor Failure, Flight Controller Failure, Airframe Failure, Telemetry Failure, and Ground Control System Failure. These CSFMs are described as follows:

Pilot Error Failure Mode: As with traditional aviation, the most likely cause of a drone crash is human pilot error. This is due to their natural fallibility and motivation to take shortcuts, or otherwise disregard rules, regulations and safe flying practices. Such shortcuts may include skipping required pre-flight checks, improperly or insufficiently charging batteries, overloading the drone, operating the drone outside allowed ambient temperature requirements, flying to higher than allowed elevations or beyond a recommended minimum battery reserve, or simply flying in an unnecessarily aggressive manner. A11 of these pilot behaviors are possible causes of drone crashes.

Battery or Fuel Cell Failure Mode: The advanced batteries and fuel cells that power modern drones employ advanced chemistries and highly reactive elements that may fail due to a manufacturer's defect or improper usage. Examples of improper usage include storing, charging, discharging, or operating the battery or fuel cell outside of manufacturer recommendations. In many cases the resulting battery or fuel cell failure causes a precipitous loss of drone power along with a possible explosion or high temperature fire. Therefore, battery or fuel cell failures are another possible cause of drone crashes.

Power Distribution System Failure Mode: Drones require power distribution systems that employ complex electronic circuits that convert electrical energy from the battery or fuel cell into the correct power supply to energize propulsion, navigation, flight control and payload systems aboard the aircraft. Failure of power distribution to any of these systems can cause these systems to go off line and lead to a drone crash.

Propulsion System Failure Mode: The propulsion system typically includes electronic speed controllers (ESCs), BLDC motors and propellers. The ESCs convert the direct current coming from the Power Distribution System into a three-phase alternating current waveform necessary to spin the BLDC motors, which then turn propellers to provide lift. Failures in any one of these Propulsion System components can cause a precipitous loss of lift or propulsion from one or more propellers, leading to a loss of drone control and the possibility of a crash.

Navigation and Obstacle Avoidance System Failure Mode: The navigation and obstacle avoidance system consists of a Global Navigation Satellite System (GNSS), an Inertial Measurement Unit (IMU), radio, radar and barometric sensors that enable the drone to accurately determine its orientation and position in the airspace (latitude, longitude and altitude), as well as any radar and other sensors necessary to detect and avoid collisions with land based or airborne obstacles. Failures in this system are another possible cause of drone crashes.

Flight Control System Failure Mode: The Flight Control System typically includes a flight control computer running software that receives navigation and motion sensor inputs, and converts piloting commands into signals to the drone's propulsion and control surfaces, resulting in the changes necessary to keep the drone stable and flying at the desired course, speed and altitude. Loss of any element of this system may lead to a drone crash.

Airframe Failure Mode: Minimizing vehicle weight and cost is a key objective of drone design. As a result, drone airframes are usually constructed from inexpensive, lightweight materials, such as plastic or aluminum. In addition, these airframes are frequently designed without redundancies in critical airframe components, including control surfaces, wings, shoulders, landing gear and motor mounts. Therefore, failure of any of these airframe components may lead to a drone crash.

Telemetry System Failure Mode: Telemetry comprises the command and control signals delivered via radio, cellular network, satellite communication and other links that connect the land based elements of the SUAS with the drone in the air. Failure of this system during flight can leave the drone in an uncontrolled state and may therefore lead to a crash.

Ground Control System Failure Mode: The SUAS ground control system may consist of any combination of handheld unit, laptop computer or cloud-based computing system that commands and controls a drone in flight. Failure of this system during flight will leave the drone in an uncontrolled state and is another possible cause of drone crashes.

Uncrewed Traffic Management (UTM) Failure Mode: The advent of advanced traffic management systems necessary to enable Beyond Visual Line of Sight (BVLOS) drone flights in urban environments is expected to increase both the frequency and potential consequences of drone collisions with other aircraft, as well as with buildings, utilities, construction equipment and other ground based structures. In most cases these collisions will result in drone crashes, thereby categorizing UTM Failure as a CSFM.

Given the historic prevalence of crash-causing Critical System Failures in SUASs, and the likely increased incidence and consequence of such failures in the future, the detection of subtle failure precursors (those otherwise unnoticeable indications that an operable component or system is likely to fail soon), followed by a combination of risk warnings and automated interventions to either prevent takeoff, avoid a collision or safely land the drone before it fails, is important to the full commercialization of SUAS technologies.

In some examples, provided is a set of hardware (sensor-based) and software methods, which together perform one or more of the following actions:

1. Detection of risky pilot behaviors likely to lead to future drone mishaps by collection and analysis of drone flight logs, telemetry logs and other SUAS data. Analysis of such data with AI/ML or other algorithmic techniques, and reporting of the resulting pilot assessments to pilot management and to the pilots themselves.

2. Detection of likely drone 102 airframe failure precursors through measurement and analysis of vibration and acoustic signals on the airframe.

3. Detection of likely battery failure precursors through measurement and analysis of individual battery temperatures, charging and discharging histories, voltages and so forth.

4. Detection of likely electrical propulsion system failures through measurement and analysis of electronic speed controller (ESC) temperatures, output line currents and voltages supplied to each motor, and stator temperatures, vibrations and acoustics at each motor,

5. Prediction of likely near-term motor failure through measurement and analysis of motor operational characteristics and detected vibration and/or acoustic signals.

6. Recommendation to the pilot via an alert on the flight control ground station not to fly a drone with predicted likely near-term air frame or motor Critical System Failure.

7. Alerting the pilot via an alert on the flight control ground station of an in-flight drone that near loss of a Critical SUAS System is likely or imminent.

8. Forcing a drone to return home and perform a safe landing in the event of imminent Critical System Failure.

The software-based methods of SUAS Critical System Failure prediction include both Artificial Intelligence (AI) and Machine-Learning (ML) based models and methods, as well as risk and impact assessment methods.

In some examples, these actions are performed by the following components and units:

1. A drone-borne fault detection component 302 comprising:
a. A current & voltage detection unit 402.
b. A thermal detection unit 404.
c. A vibration detection unit 406.
d. An acoustic detection unit 408.
e. An optical detection unit 410.
f. A battery detection unit 412.
g. An operational detection unit 414.

2. An ML fault detection component 304 that accepts the outputs (signals or data) from the different sensor units of the fault detection component 302 and/or the fault detection component 302 itself as inputs, and uses an AI/ML based aggregate analysis to arrive at a final fault detection decision.

3. A pilot performance component 306 that accepts the outputs (signals or data) from the different sensor units of the fault detection component 302 and assesses them against expected drone performance metrics for the particular flight.

4. A CSFM risk prediction component 308 that receives the outputs from the fault detection component 302, ML fault detection component 304 and pilot performance component 306 and based thereon predicts the risk of the drone 102 entering a CSFM. The CSFM risk prediction component 308 comprises a:
a. SUAS borne data repository and mobile AI/ML analysis engine.
b. Cloud based Data warehouse and AI/ML engine architecture.
c. Flight control software interface component.

5. An Autonomic In-Flight recommendation & intervention engine 310 that receives output from the CSFM risk prediction component 308 and determines appropriate recommendations from a trained AI/ML model based on the particular CSFM identified and the associated likelihood of it occurring.

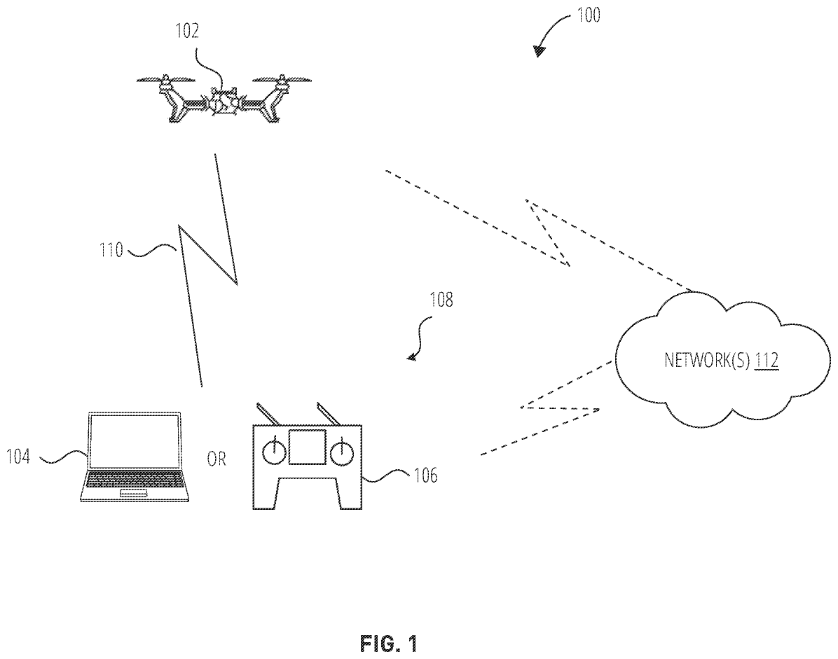

FIG. 1 illustrates a high-level view of a small uncrewed aerial system (SUAS), according to some examples. The SUAS 100 consists of a commercial grade drone 102 with an onboard flight control computer running flight control software. In some examples the drone 102 is flown by a licensed ground-based pilot, utilizing a handheld controller 106 or laptop computer 104 running ground control software. The laptop computer 104/handheld controller 106 thus operates as a ground control station 108, which communicates with the drone 102 via local radio frequency (RF) wireless transmissions 110. In some examples, in-flight failure mitigation may be implemented locally through an API interface between the recommendation & intervention engine 310 and the flight control software in the drone 102 or in the or ground control software in the ground control station 108.

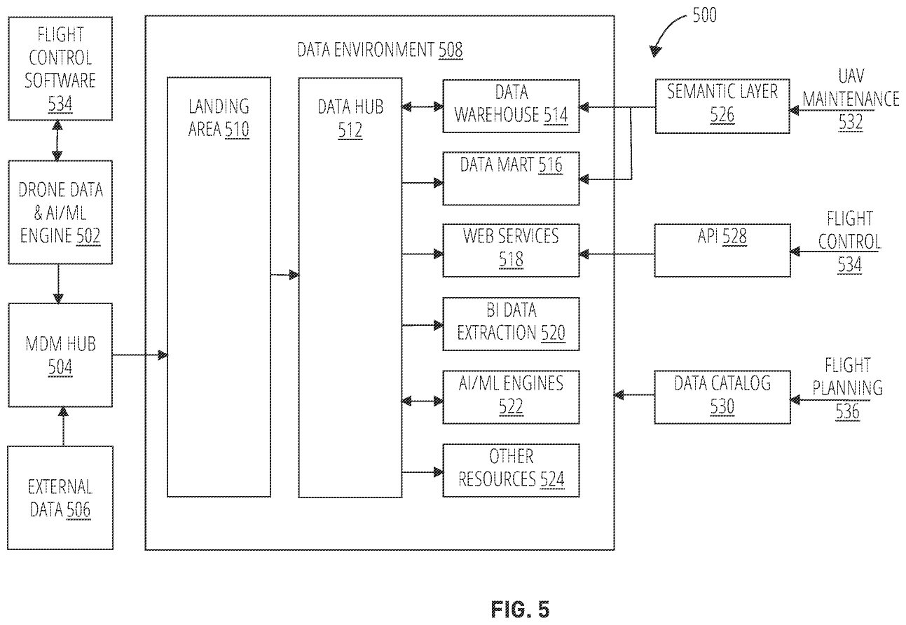

In some examples, additional transmissions of data may be made to, and commands or recommendations may be received from, a cloud-based data platform and AI/ML engine architecture 500 (see FIG. 5) via network(s) 112, either directly to the ground control station 108 or the drone 102, or to the drone 102 using the ground control station 108 as a relay.

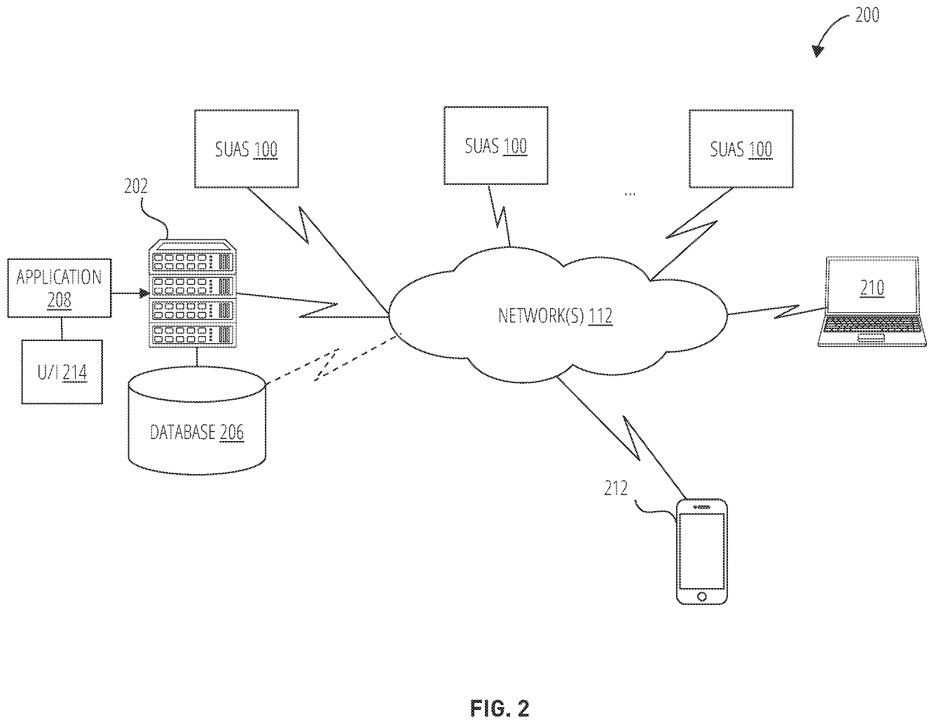

FIG. 2 illustrates a high level view of a Small Uncrewed Aircraft Fleet (SUAF), according to some examples. The SUAF 200 includes a plurality of SUASs 100 along with the network computing capabilities and personal computing devices necessary to implement the methods and systems described herein, each of which is communicatively coupled to one or more network(s) 112.

The network(s) 112 may be any type of known networks including, but not limited to, a wide area network (WAN), a local area network (LAN), a global network (e.g. Internet), a virtual private network (VPN), and an intranet. The network(s) 112 may be implemented using wireless networks or any kind of physical network implementation known in the art, e.g., using cellular, satellite, and/or terrestrial network technologies. The network(s) 112 may also include short range wireless networks utilizing, e.g., Bluetooth and Wi-Fi technologies and protocols.

The SUAF 200 also includes a host system computer 202, which is communicatively coupled to one or more of the network(s) 112. The host system computer 202 may be implemented as one or more high-speed computer processing devices capable of handling a high volume of activities related to the SUAF 200. The host system computer 202 also implements one or more applications 208 to manage the various functions related to the SUAF 200. The application 208 includes a user interface 214 that is presented to end users via a personal computer 210 and a mobile device 212.

A storage device 206 is coupled to the host system computer 202 and may be alternatively coupled to the host system computer 202 via one or more of the network(s) 112. The storage device 206 stores a variety of data used by the host system computer 202 in implementing the methods described herein. It is understood that the storage device 206 may be implemented using memory contained in the host system computer 202 or may be a separate physical device, such as a server located locally or remotely. The storage device 206 is logically addressable as a consolidated data source across a distributed environment that includes the network(s) 112.

The host system computer 202 also operates as a database server and coordinates access to application data including data stored in the storage device 206. The host system computer 202 may be implemented using one or more servers operating in response to a computer program stored in a storage medium accessible by the server. The host system computer 202 may operate as a network server (e.g., a web server) to communicate with the personal computer 210 and the mobile device 212 and other network entities.

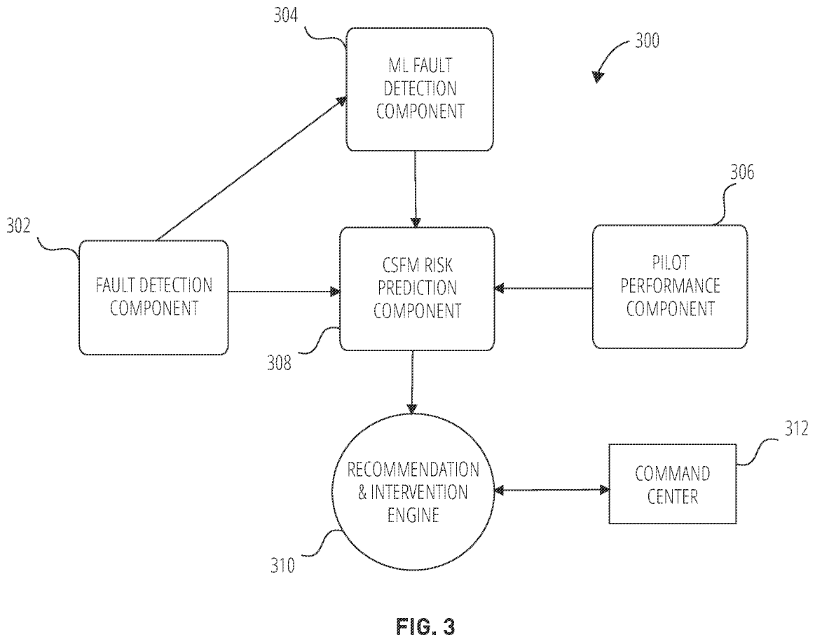

FIG. 3 illustrates a system architecture 300 for the SUAS 100, as it relates to airframe and electrical propulsion system failure prediction, detection and mitigation, according to some examples. The system architecture 300 includes a fault detection component 302, ML fault detection component 304, pilot performance component 306, CSFM risk prediction component 308 and recommendation & intervention engine 310. The recommendation & intervention engine 310 in turn transmits and receives data, recommendations and/or instructions to and from a command center 312.

The fault detection component 302 detects the existence of known faults that may occur in the drone 102, based on known indicators. For example, complete motor failure detected by a motor no longer drawing current, battery failure detected by a critical temperature threshold being breached or the drop in a voltage level below a specified threshold, and so forth. Faults detected by the fault detection component 302 are reported to both the ML fault detection component 304 and the CSFM risk prediction component 308.

The fault detection component 302 includes a detailed taxonomy of motor faults that can be used to identify the onset of possible root causes of failure, including worn or loose airframe components, high motor or ambient temperatures, bearing friction increase, open-phase circuits, loose wiring connectors, cracked or broken rotors, degraded electronic components, back EMF signal errors and so forth, based on the outputs received from the detection units 402 to 414.

The ML fault detection component 304 uses one or more trained machine learning models to detects the existence of nascent drone faults that may be developing, based on drone related data. The ML fault detection component 304 also detects faults or mishaps, or nascent faults or mishaps, that may not be detectable based on a known indicator as for the fault detection component 302, such as CSFMs that may occur as a result of a combination of faults or a combination of unusual data that individually is within tolerances.

The pilot performance component 306 uses one or more machine learning or AI models, as well as direct comparisons with flight planning data, to assess pilot performance. For example, the pilot performance component 306 will detect departure of the drone from a planned flight path or designated area based on a comparison of the position and movement of the drone 102 with a flight plan or flight restrictions, and will also identify erratic flight behavior occurring within the bounds of a flight plan or flight restrictions, which may indicate a problem with the pilot, connectivity, the drone 102 itself, and so forth.

The CSFM risk prediction component 308 receives data from the fault detection component 302, ML fault detection component 304 and pilot performance component 306 and based thereon predicts the risk of the drone 102 entering a CSFM, which is then reported to the recommendation & intervention engine 310. The CSFM risk prediction component 308 also reports any CSFM that is occurring or imminent based on received data.

The recommendation & intervention engine 310 in turn receives the output from the CSFM risk prediction component 308 and determines an appropriate recommendation or an automated response, using a trained AI/ML model based on the particular CSFM identified and the associated likelihood of it occurring. The recommendation & intervention engine 310 provides the recommendation or action to the command center 312, which may be the ground control station 108, a data environment 508 (see FIG. 5) hosted by the host system computer 202, or, in the case of an automated response, flight control software or logic hosted in the drone 102 itself.

The operation of the ML fault detection component 304, the pilot performance component 306, the CSFM risk prediction component 308 and the recommendation & intervention engine 310 may be supplemented by analysis, data and/or instructions from ground based infrastructure such as the ground control station 108 or data environment 508, which will have more processing power than is hosted on the drone 102.

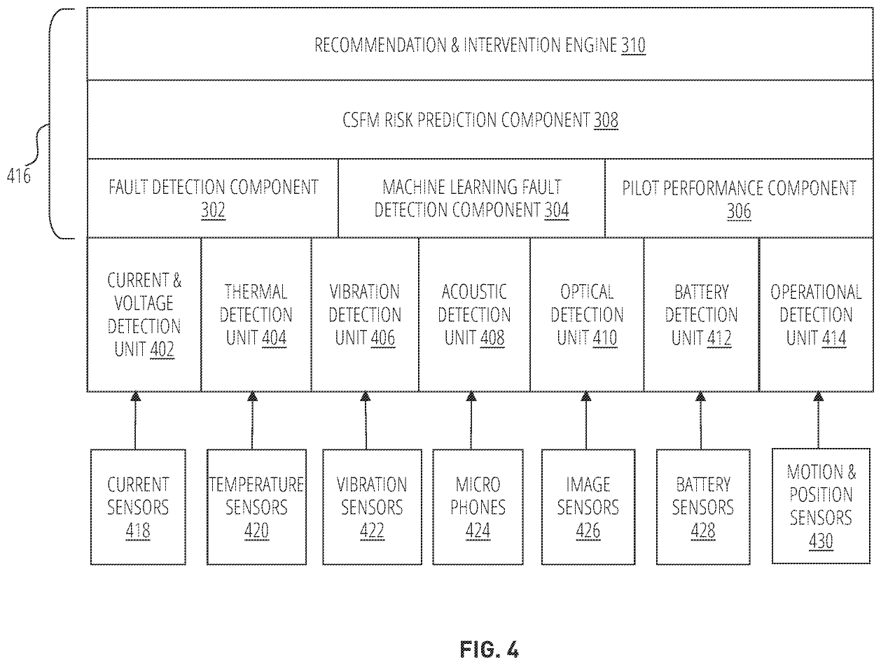

FIG. 4 illustrates the system architecture 300 of FIG. 3 in more detail, according to some examples. As can be seen the fault detection component 302, ML fault detection component 304 and pilot performance component 306 receive inputs from one or more detection units, including a motor current & voltage detection unit 402, a motor thermal detection unit 404, a vibration detection unit 406, an acoustic detection unit 408, an optical detection unit 410, a battery detection unit 412, and an operational detection unit 414, each of which independently collect and monitor during pre-flight maintenance testing and also during operational flights.

These components utilize sensors located at various locations in the drone 102 for the detection of variations in temperature, current, vibration, sound and battery individual cell voltage and temperature, and so forth. An ML ensemble 416 including the fault detection component 302, ML fault detection component 304 and pilot performance component 306, receives and integrates the outputs from these systems, suitably combined with other structured and unstructured data sources pertinent to the SUAS 100. Such data sources include: maintenance history logs, flight data from similar faults and crashes, as well as other similar events of interest to detect nascent and developing faults and possible CSFMs and their temporal progression within the SUAS 100.

The fault detection component 302 may be embodied as a multi-sensor printed circuit board (PCB), including a current & voltage detection unit 402, thermal detection unit 404, vibration detection unit 406, and an acoustic detection unit 408, an optical detection unit 410, a battery detection unit 412 and an operational detection unit 414, which are implemented in one or more data processors located on the PCB. Relevant outputs from units 402 to 414 are provided to the ML fault detection component 304 and pilot performance component 306, either directly or via the fault detection component 302

The fault detection component 302, ML fault detection component 304 and pilot performance component 306 and their sub-units (402, 404, 406, 408, 410, 412, 414) independently and jointly detect the likelihood, presence and progression of CSFMs, such as airframe and electrical propulsion system faults during pre-flight maintenance testing, and in flight.

The current & voltage detection unit 402 receives input from current sensors 418, which sense the current drawn on all three phases of each motor from its respective electronic speed controllers (ESC). The thermal detection unit 404 receives input from temperature sensors 420 located on the battery(ies), ESCs and motor stators. The vibration detection unit 406 receives input from multiple vibration sensors 422 mounted throughout the drone 102. The acoustic detection unit 408 receives input from one or more microphones 424, the optical detection unit 410 receives input from one or more image sensors 426, while the operational detection unit 414 receives input from one or more motion & position sensors 430.

The current & voltage detection unit 402 is primarily concerned with abnormalities in electric current consumption. For example, low line voltage or excess motor load due to bearing failure or propeller damage could result in excess current flow to one motor that is measurably higher than in the other motors on that aircraft. The primary inputs to the current & voltage detection unit 402 are voltage, amperage, and temperature. At constant power (P), if voltage (V) drops then current (C) and temperature (T) rise. At constant V as (P) increases then (C) and (T) increase commensurately. If either of these conditions exist at sufficient magnitude for a prolonged period of time then SUAS motor failure may be imminent. C-V-T interactions and magnitudes are thus used as inputs for the fault detection component 302. Most brushless direct current (BLDC) motor ESCs have current and voltage sensors already built into them. The signal provided by sensors are used by the current & voltage detection unit 402 for motor diagnostics. BLDC inverters also typically have microprocessors or DSPs for motion control. The current & voltage detection unit 402 can easily be integrated into these pre-existing processors.

The current & voltage detection unit 402 recognizes the rotor and fault signatures produced in BLDC motors that are detectable from variations in current, voltage and temperature, and estimates the severity of the fault both under stationary and non-stationary operating conditions. The current & voltage detection unit 402 includes a taxonomy of various kinds of rotor and load faults that can occur in a BLDC motor. The taxonomy is embodied in an algorithm, such as the windowed Fourier ridges method, to provide constant monitoring of motor health, with a mapping of each detected fault to the most likely causes from the taxonomy encoded as a list.

Output from the current & voltage detection unit 402 is provided as an input to the ML ensemble 416, which also takes into account inputs from the other sensing components for its final predictions and recommendations.

The thermal detection unit 404 monitors battery, ESC and motor stator temperatures using the temperature sensors 420. Excessive temperatures in motors, batteries and ESCs is a reliable precursor to failure of these critical components and a possible cause of crashes. Maximum temperature ratings are often provided with electric motors, but it can be unclear when a motor is approaching these limits. The thermal sensing unit is used for conducting pre-flight thermal evaluations of electric motors, as well as in-flight thermal fault monitoring.

By doing thermal evaluations early in the SUAS design process, a motor's thermal characteristics and threshold temperature at which subsequent failure is likely can be determined. By utilizing a motor test stand, a motor and ESC may be placed under carefully controlled loads and ambient temperature conditions to generate training data for one or more of the modules in the ML ensemble 416.

The vibration detection unit 406 and acoustic detection unit 408 detect unusual vibrations as well as unusual sound patterns to detect impending failures under five categories: airframe, propeller, eccentric loading, ESC, and motor bearing and stator failures. The vibration detection unit 406, the acoustic detection unit 408 and the ML ensemble 416 together form an ensemble machine learning model that is able to detect these types of failures as well as discern their likely root causes. The noise and vibration generated by and in a drone 102 as a result of bearing failure, load imbalances and motor stalls, will each have distinctly different vibration and acoustic signatures. For example, bearing failures due to insufficient lubrication, short-circuit at coil due to unbalanced propeller vibration, and loose windings due to the same can be distinguished from each other with vibration and acoustic data.

The vibration detection unit 406 monitors the operational state of a drone 102 based on data reported from one or more vibration sensors 422, which may form part of an 's Inertial Measurement Unit (IMU), as well as specially generated (proprietary) motor vibrational data determined during the design and testing phase. Anomaly detection and deep learning methods are used by the vibration detection unit 406 to detect vibrational anomalies in the motors of the drone 102, and hence the specific motor and bearing failure patterns in the vibrational signals.

Additionally, by providing a lightweight microphone 424 for detecting the sound generated by the rotors and the motors, the sound acoustic detection unit 408 provides an abnormal sound detection machine learning model that complements the vibration detection unit 406. The machine learning model in the acoustic detection unit 408 is generated using supervised deep learning, via a case-based identification algorithm, derived from sound data developed using development and testing.

Among the predominant causes of a motor thermal failure is a faulty mechanical connection. For example, if one of the motor fastener screws is protruding into the motor casing and making contact with the windings, it can eventually lead to a thermal failure. Timely diagnosis of this root cause will be enhanced by use of the vibration detection unit 406 and acoustic detection unit 408.

The optical detection unit 410 in some examples is used to identify nascent thermal events using inwardly-facing image sensors 426, to detect unexpected movement, such as tilting of the 120, from frame to frame or over a number of frames using outward-facing image sensors 426, and to detect component positional anomalies using the inwardly-facing sensors. The image sensors 426 consists of multiple small in-flight visual spectrum and/or infrared cameras, which record photogrammetric data for optical inspection of developing faults and assessment of flight dynamics. The image sensors 426 facing inward towards internal components can be used to detect mechanical changes that occur between subsequent image frames, for example the loss or movement of a visible screw or other relative movement or deflection between components, or can capture heat maps that can be used by the optical detection unit 410 to track, monitor and identify problematic thermal behavior within the drone 102.

The battery detection unit 412 uses dedicated battery sensors 428, such as temperature, current and voltage sensors built into the battery packs or battery cells to monitor battery performance and behavior, and provide relevant data and fault detection signals to the ML ensemble 416.

The ML fault detection component 304 uses data generated or reported by one, some or all of the detection units 402 to 414 and the fault detection component 302 using one or more trained ML models. For example, to identify a nascent motor thermal failure, ML ensemble 416, and in particular ML fault detection component 304, uses data from the thermal detection unit 404 and temperature sensors 420, augmented by features extracted from other related data sets (vibration, sound, current), laboratory experimental datasets, as well as fault records and other data in the maintenance logs. Owing to the richness of the patterns in such master data sets, application of machine learning makes it possible to provide granular root cause analysis and consequences analysis to predict and identify the root-causes of motor thermal failures and their consequences.

The ML ensemble 416 thus combines sound-based methods, vibration sensing methods, optical sensing methods, battery monitoring methods, as well as the current monitoring and thermal sensing inputs via a deep learning ensemble for a more granular detection of the root causes with resultant better accuracies in predicting both the occurrence of each type of CSFM, its likely time to failure, and the root cause.

Prediction of failure risk, such as in air frames and propulsion systems, in use is performed by the CSFM risk prediction component 308, which receives operation data from the other components in the system architecture 300 as described above. The risk prediction is based on data mining and machine learning on four specific data sources (i) large datasets collected from the flight records of drones integrated over hundreds of thousands of flight hours, such as a Drone Crash Database; (ii) relevant unstructured data such as written reports, maintenance logs and notes, video and audio surveillance records on similar drones 102, where specific failures, such as a motor failure or a battery failure, are identified to be a key cause of failure; (iii) specific flight and safety records of the particular drone 102 in question, for which the failure risk prediction component is being applied; and (iv) maintenance diagnostic test outcomes and data from the fault detection component 302, including temperature and sensor data and service log data collected during routine maintenance of the specific drone 102.

Simultaneously, prediction of the human pilot's performance soundness and the associated risk is performed by the pilot performance component 306, which receives data from the operational detection unit 414. The operational detection unit 414 in turn receives data from motion & position sensors 430 such as a GPS and inertial measurement unit in addition to flight plan data. Flight data and possible deviations from expected flight behaviors are detected by the operational detection unit 414 and reported to the pilot performance component 306.

The pilot performance component 306 uses Machine Learning and Generative AI (Foundational models) to assess, predict and detect failure factors associated with the Liveware in the standard aviation SHEL model, consisting of the SUAS Software, Hardware, Environment (conditions in the storage facility, in the air during flight and in the work environment) and Liveware (i.e., the person or people at the center of the model, including pilots, maintenance technicians, supervisors, planners, managers, etc.). Human factors related to the Liveware, especially the pilots remotely controlling the SUAS include human physiology, Psychology (including perception, cognition, memory, social interaction, error, etc.), Workplace design, Environmental conditions, human-machine interface and anthropometrics. In aviation, up to 70% of the accidents are attributed to human error. SUAS have typically experienced a significantly higher accident rate than conventionally piloted aircraft. In the early 2000s, accident rates for some drones were between 30 and 300 times higher than the comparable rate for general aviation.

Physical separation of the pilot from the aircraft, control via radio signals, and a remote control interface are unique challenges to the pilot and control staff of an SUAS 100, introducing a set of human factors that are not typical of conventional aviation. Lacking the ability to hear the sound of hail on the fuselage, smell an onboard fire, feel turbulence, or notice ice accumulating on a windshield, the remote pilot relies almost entirely on visual displays to monitor the state of the aircraft. Even when the SUAS 100 is equipped with a first-person view camera, the image quality may be limited, and the field of view may be reduced to a narrow “soda straw” picture. In addition, the command and control link between pilot and SUAS 100 may be lost due to multiple types of pilot error, including: flying beyond the range of the ground station, flying into an area where the signal is masked by terrain, frequency selection errors, abrupt aircraft maneuvers, physical disruptions to plugs and cables, radio frequency interference and electronic lock-outs in which a screen lock or security system prevents access. These factors represent unique SUAS flight risks that can be addressed through Machine Learning and Generative AI.

Currently, before an SUAS 100 can be integrated into civil airspace, the remote pilot must have a means to “see and avoid” other aircraft whenever conditions permit (14 CFR 91.113; ICAO, 2011) and to comply with other air traffic requirements that rely on human vision. Detect and Avoid (DAA) systems require the pilots to (1) remain well clear of other aircraft and (2) collision avoidance. Furthermore, a unique feature of SUAS is that control may be transferred in-flight between adjacent consoles, or between geographically separated control stations. Transfers can also involve a change of control link, such as from satellite to terrestrial radio communications.

Displays to assist the pilot in remaining well clear can be informative, suggestive or directive, and the pilot must be able to respond to all three sources of information in time. Unlike in crewed aircraft where it is clear who is in command, with SUAS operations, there are multiple people who have a sense of responsibility for the aircraft, who collaborate with the pilot at the GCS [Ground Control Station]. Remote pilots also need to be alert and capable of flight termination decisions, communication and coordination with remote crew members, control transfers, and the impact of reduced sensory cues on threat and error management.

In light of the above considerations, prediction of the human pilot's performance soundness and the associated risk is based on machine learning on data sources on the human factors related to the Liveware, especially the pilots remotely controlling the drone 102. These factors include data about physiology and health of the pilot, psychology (including perception, cognition, memory, social interaction, error, etc.), workplace design of the control station and maintenance stations, environmental conditions about the flight, the human-machine interface and the various software and UI factors which either aid or adversely impact the pilot's performance. Generative AI and ML are used for (i) the identification of unusual pilot behavior by the pilot performance component 306 based on the application of trained ML models to data generated by the other components of the system architecture 300, flight plan data and historical data, (ii) prediction of failure or accident risk by the CSFM risk prediction component 308, and (ii) alerting of the pilot and fellow staff in control of the flight, and recommendation of measures to mitigate the risk due to human (pilot) errors by the recommendation & intervention engine 310. The pilot performance component 306 is designed to work in concert with, and exchange data with the other failure prediction components.

FIG. 5 illustrates a cloud-based data platform and AI/ML engine architecture 500, according to some examples. The architecture 500 is used to collect, extract, curate and prepare data from multiple SUAS 100 data sources necessary for the AI, ML and Natural Language Processing (NLP) models' training and testing. The relevant datasets mentioned in conjunction with the components described herein are hosted on this data platform and architecture 500. The data assets contain structured data including maintenance and inspection logs, flight records and sensor data, and so forth. The data assets also contain unstructured data such as images, text, audio records of speech and sounds/vibrations and video recordings, and records of all flight and inspection events. Such data is collected with respect to each particular drone 102 as well as from records of drones having a similar configuration, which contribute to improved machine learning and prediction based on similarity.

The pilot performance component 306 is an ensemble of three modules: a Classical ML module, a Generative AI module and a Deep Learning module, integrated to build a pilot performance intelligence platform, as follows;

Generative AI: By leveraging the power of generative models, such as Generative Adversarial Networks (GANs) and Variational Autoencoders (VAEs), it is possible to simulate various scenarios and generate synthetic data that can be used to improve the performance of SUAS pilots and trained AI/ML models. Generative AI can be utilized in the following contexts:

Data Augmentation: Generative models can be employed to augment the limited dataset of SUAS flights. By generating synthetic flight data, the pilots can be exposed during training to a more diverse range of scenarios, which helps the pilot improve their skills in handling different situations. Data augmentation increases the robustness of the pilot's training and leads to better performance in real-world scenarios.

Anomaly Detection: Generative models can be used to create a model of normal flight patterns or flight plans, in general or for a specific mission. Any deviations from this norm can be flagged as anomalies, indicating potential performance issues or safety risks. This way, SUAS pilots can receive early warnings about their actions that might lead to problematic outcomes, allowing them to correct their behavior and prevent accidents.

Flight Simulation: Advanced generative models can create highly realistic flight simulations, mimicking real-world conditions. These simulations provide a safe and controlled environment for pilots to practice and refine their skills without any risk to actual equipment or personnel. It also allows them to experiment with different strategies and maneuvers.

Personalized Training: Generative AI can analyze the performance of individual SUAS pilots and create personalized training programs to address their specific weaknesses. By understanding each pilot's strengths and weaknesses, the training can be tailored to focus on areas that require improvement, leading to more effective skill development.

Performance Prediction: Generative models can predict the performance of SUAS pilots under various conditions, based on historical data and training. This allows supervisors and trainers to assess a pilot's readiness for specific missions or tasks, helping to allocate resources more efficiently and reduce the risk of unsuccessful missions.

Real-time Feedback: Generative AI can be integrated into the SUAS 100 to provide real-time feedback to pilots during flights. For instance, if the system detects potential mistakes or suboptimal decisions, it can alert the pilot to take corrective actions, thereby enhancing situational awareness and decision-making.

Expert-Level Imitation: Generative models can be trained on data from expert SUAS pilots, learning their high-level strategies and decision-making processes. This enables the generative model to provide suggestions or corrections during a flight, effectively acting as an expert-level mentor for less experienced pilots.

In addition, the scenarios provided by Generative AI, the actual pilot responses thereto, and resulting simulated outcomes to can be used to refine the ML ensemble 416 by including the generated scenarios and related appropriate and inappropriate responses thereto, and consequences thereof, in the training data for the models comprising the ML ensemble 416. This enables additional situations that might lead to mishaps or crashes to be included in the training of the pilot performance component 306, CSFM risk prediction component 308 and recommendation & intervention engine 310 in particular.

Several algorithms can be used in the context of using Generative AI for SUAS pilot performance prediction and correction. In some examples, the following key algorithms can be applied:

Generative Adversarial Networks (GANs): GANs are a popular class of generative models used for creating realistic synthetic data. In the context of SUAS pilot performance prediction and correction, GANs can be employed to generate diverse and realistic flight scenarios. The generator network creates synthetic flight data, and the discriminator network evaluates its realism. Through adversarial training, the generator improves its ability to create flight data that closely resembles real-world scenarios.

Variational Autoencoders (VAEs): VAEs are another type of generative model that can be used for SUAS pilot performance prediction and correction. VAEs learn a probabilistic representation of the input data, allowing for the generation of new samples from the learned latent space. In this context. VAEs can be used for data augmentation, synthesizing new flight patterns based on the learned representations of existing data.

Sequence-to-Sequence Models: Sequence-to-sequence (Seq2Seq) models are used for tasks that involve generating sequences of data based on input sequences. In the context of SUAS pilot performance, these models can be used to predict future flight trajectories or pilot actions given past flight data. This information can be valuable for predicting potential mistakes or suboptimal decisions, allowing for real-time feedback to the pilot.

Reinforcement Learning: Reinforcement Learning (RL) is a type of machine learning where an agent learns to interact with an environment to maximize a reward signal. In the context of SUAS pilot performance correction, RL can be used to provide guidance and suggestions to pilots during flights. The RL agent can learn from expert pilots' data and offer corrective actions or optimal strategies to less experienced pilots.

Deep Q-Networks (DQNs): DQNs are a type of RL algorithm used for solving control problems. They use deep neural networks to approximate the action-value function and guide the agent's decision-making process. In the context of SUAS pilot performance, DQNs can be used to suggest appropriate actions or maneuvers during flights, ensuring the pilot makes informed decisions.

Long Short-Term Memory (LSTM) Networks: LSTM networks are a type of recurrent neural network (RNN) capable of handling sequential data. They are particularly useful for tasks where the order and context of data matter. In the context of SUAS pilot performance prediction. LSTMs can be used to model and predict the pilot's actions over time, allowing for personalized training and performance assessment.

Gaussian Mixture Models (GMMs): GMMs are used for clustering and modeling data distributions. In the context of SUAS pilot performance, GMMs can be applied to identify patterns and clusters in pilot behavior. This information can be used to understand common mistakes or identify areas that require improvement for specific pilots.

Bayesian Networks: Bayesian Networks can be used to model the conditional dependencies between different events and actions. In the context of SUAS pilot performance prediction, Bayesian Networks can help in understanding the causal relationships between pilot decisions and their outcomes. This knowledge can aid in providing personalized feedback and guidance to pilots.

Several data sources and types of data can be valuable for training, evaluation, and real-time applications. Examples of useful data sources and data types include:

Flight Data from Real SUAS Missions: The primary and most important data source would be actual flight data collected from SUAS missions. This data would include information about the SUAS's position, altitude, velocity, orientation, sensor readings, control inputs, and other relevant telemetry data. This real-world data provides the basis for training and validating the generative models and performance prediction algorithms.

Simulated Flight Data: Synthetic flight data generated from accurate flight simulators can supplement the real-world data. These simulations can cover a wide range of scenarios, weather conditions, terrains, and potential emergencies, providing a diverse dataset for the generative models and reinforcement learning algorithms to learn from.

Expert Pilot Data: Data from expert SUAS pilots who have a history of successful and safe missions can serve as a valuable source of knowledge for generative models. By learning from the patterns and strategies of expert pilots, the generative models can provide guidance and suggestions to less experienced pilots during their flights.

Annotated Anomaly Data: Data with annotations or labels indicating anomalies or safety-related incidents during SUAS flights are crucial for training anomaly detection algorithms. This data would allow the system to recognize unusual patterns and deviations from normal behavior, triggering alerts and corrections when necessary.

Pilot Training Records: Records of pilot training sessions, performance evaluations, and feedback can be used to personalize training programs. By understanding each pilot's strengths and weaknesses, personalized training can be designed to address specific areas of improvement.

Environmental Data: Information about weather conditions, geographic features, airspace regulations, and other environmental factors can be integrated into the training and prediction models. These data help the models adapt to different conditions and make more informed decisions.

Historical Performance Data: Historical data on pilot performance, mission success rates, and incidents can be used for analyzing trends and patterns. This information can inform the design of performance prediction algorithms, allowing the system to anticipate potential issues.

Sensor Data: Data from various sensors onboard the SUAS, such as cameras, LiDAR, GPS, and other environmental sensors, can be used to create a holistic view of the flight scenarios. These data sources enable the generative models to generate realistic flight simulations and provide accurate real-time feedback to pilots.

While using real-world data is valuable, access to such data might be limited due to privacy, security, or operational concerns. In such cases, carefully generated and curated synthetic data can be a useful alternative for training generative models and reinforcement learning algorithms. Additionally, a combination of real and simulated data can be used to create a more comprehensive and diverse dataset for better performance prediction and correction.

A fault detection Master Data Structure is constructed from a combination of standard structured and unstructured fault and failure data formats, such as Flight Summary Reports. These base fault and failure data sets are combined with in-flight and on-ground (maintenance lab) data sets to create a comprehensive data repository of failures and failure-influencing variables, from which the machine learning models are trained both initially and continuously as the data repository is updated.

As can be seen from the figure, the architecture 500 includes Drone Data & AI/ML Engine 502, a Master Data Management hub 504, and external data 506. Data is exchanged between the Master Data Management hub 504 and a data environment 508 including communication and computing infrastructure at a landing area 510. AI so provided in the data environment 508 are related components and services such as a data hub 512, a data warehouse 514, a data mart 516, web services 518, BI data extraction 520, AI/ML engines 522 and other resources 524.

In some examples, the Drone Data & AI/ML Engine 502, arranged according to the system architecture 300, is hosted in the computational equipment in the drones 102 themselves. In other examples, a miniature version thereof is hosted on the computational equipment in the drone 102 itself, for agile runtime AI/ML based predictions. This is referred to as Edge AI, in which the limited computational resources on the drone 102 are used in conjunction with a more resourceful remote or local AI/ML engine (the Core AI), for example located on a server or in the ground control station 108, with which the Edge AI communicates to conduct the necessary predictions and interventions quickly in real time. In such a case, the choice of where to host each component of the ML ensemble 416, or the use of different complexities of AI/ML levels for an ML ensemble 416 on the drone 102 versus on the server and/or on the ground control station 108 is a matter of design choice based on available computational, battery and connectivity resources.

In some examples, the pilot of a drone 102 is required to be on-site and maintain a line of sight with the drone 102 while it is in flight. In some cases, cellular or other long-range connectivity between the drone 102 and the data environment 508 may not be available or may not be permitted. The use of Edge AI however permits impending CSFMs to be identified, and recommended actions (if not automated) to be transmitted from the drone 102 to the ground control station 108, running flight control software 534, irrespective of whether or not a connection to the Core AI is available.

The Edge AI approach thus both avoids some round-trip data transmission costs from the drone 102 in flight back to the data warehouse and computing center at the remote ground command and control center, and enables impending CSFMs to be identified and acted upon in environments where transmission signals are restricted.

The CSFM risk prediction component 308 and recommendation & intervention engine 310 coupled to and integrated with the flight control software 534 and flight planning 536 software via API and HPI (hardware programming interfaces), which together enable control of the drone 102 flight plan and direction, to mitigate failures. For example, upon determining that a particular type of airframe or electrical propulsion fault that is developing during flight will be detrimental to the drone 102 and/or the payload, the necessary interventions can be automated through API or HPI control of the flight control software 534 by the recommendation & intervention engine 310 for a safe and timely return to the ground and landing. Flight planning data can be loaded and cataloged into the environment via a data catalog 530.

In some examples, the flight control software 534 is provided with an electro-mechanical systems simulator to visually display the evolving airframe, electrical propulsion or other faults, the associated risks, root causes and intervention recommendations using video and audio (speech instruction) signals and commands for the pilots. Additionally, in the case of the AI/ML models identifying more than one possible fault and associated recommendation, the flight control software 534 can provide ‘what if simulations’ and estimated likelihoods of each occurring, to aid the decision making while troubleshooting during runtime, in terms of which intervention could lead to which type of remedial states. Flight control data from flight control software 534 can also be transmitted and processed for storage or analysis by the data environment 508 via an API 528.

Natural languages and the ability to find latent patterns from expressions in a natural language using a convolutional neural network (CNN) or a Recurrent Neural Network (RNN) with or without Long Short Term Memory (LSTM) can also be of benefit in the SUAS 100. Within such a convolutional network is a convolution layer that comprise multiple filters of variable sizes whose weights are learned during a training process. A convolution is a matrix operation on the input data performed by sliding a filter on the data to extract feature maps. Every filter is slid such that the entire input is covered (how a filter slides can be controlled by defining “strides”.) There are three types of layers in a CNN—an input layer, feature-extraction layers and classification layers. Input layers take multi-dimensional embedded text as input. Collectively, the classification layers comprise a dense layer that sends the learned features forward to output classification scores (similar to Bayesian probabilities), which serve as the basis for risk score prediction, fault root-cause classification and intervention recommendation.

A Natural Language Processing (NLP) Engine including speech recognition is used as one of the AI/ML engines 522, to analyze unstructured data in the form of text and human speech. Textual records such as call central logs, auto shop audio/video reports converted to text, inspection records and accident reports in the form of text, technical documentation about the SUAS engine specifications and performance, information from websites, technical blogs, social media data from such sources as LinkedIn, Facebook and Twitter are put into the NLP engine in question and serve as valuable natural language data with information related to performance, risk and failure. Similarly, human speech audio records collected during the flight of a particular drone 102 and s similar to it in historic records are additional sources of data.

BERT (Bidirectional Encoder Representations from Transformers) is an AI technique enabling advanced NLP tasks, including Question Answering (SQuAD v1.1), Natural Language Inference (MNLI), and others. BERT can be used to predict fault probability and risk from the natural language generated in texts and conversations detailed above. BERT applies bidirectional training of a transformer (an attention mechanism that learns contextual relations between words or sub-words in text), a known NLP attention model, to language modeling, continuously inspecting text sequences both from left to right and right-to-left training.

For example, a sentiment analysis approach could be used as part of a semantic layer 526 for classifying the current status of a drone 102 or UAV maintenance 532 data into pre-defined risk categories. A Long Short-Term Memory (LSTM) neural network and other similar approaches can also be used to predict fault and failure probabilities using text and language inputs (speech etc.)

Fault detection can also be performed using Structured Data and Recurrent Neural Networks (RNN) Here, relevant structured data sources are in the form of log files that contain data about all the activities performed during the manufacture, inspection & maintenance and flight events of SUAS. Data relevant for this Deep Learning unit comes from many different sources, such as the inspection logs, maintenance reports and flight event logs. RNN and LSTM can be used on such structured data, in which the LSTM is utilized to mine the logs as a sequence of natural language or time series record of logs, wherein the model extracts features and detects anomalies when log patterns deviate from their trained models and indicate a fault or failure.

By combining the methods and models described above into an AI ensemble, to provide an integrated ML model ensemble, better accuracies of prediction are yielded compared to any single ML model, as outputs from the multiple ML algorithms can be combined to obtain better predictive performance than could be obtained from any of the constituent ML algorithms alone. As an essential part of such ensembles, Generative AI will be applied to SUAS failure prediction and mitigation in the following ways.

Anomaly Detection to learn the normal behavior of SUASs by training on a large dataset of normal flight patterns. Any deviation from the learned normal behavior will be flagged as an anomaly, indicating a potential failure or malfunction. This will help in early detection of issues before they become critical.

Predictive Maintenance by learning patterns that precede specific failures or malfunctions. This knowledge will be used to predict when components are likely to fail, enabling proactive maintenance and reducing the risk of unexpected failures during flight.

Fault Diagnosis by being trained to identify the root cause of a failure based on sensor data collected during a flight. By correlating patterns in the data with known failure modes, the models will provide insights into the specific component or system that is likely to be malfunctioning. The Generative AI component will continuously monitor sensor data and make real-time adjustments to flight parameters based on the current state of the SUAS. By dynamically adapting to changing conditions and potential failures, the SUAS will optimize its performance and improve safety.

The generative AI in some examples will also be used create realistic simulations of SUAS flight and failure scenarios. These simulations will help in testing and validating new SUAS designs, as well as training pilots and maintenance personnel in handling various failure situations. By simulating failure scenarios, the models will aid in developing robust mitigation strategies ahead of the flight. In the event of a failure or critical malfunction, generative AI will assist in enabling autonomous recovery of the SUAS by creating immediate and unique responses to particular scenarios, without the recommendation & intervention engine 310 having to have fixed responses for all possible scenarios. By analyzing sensor data and understanding the current state of the SUAS, the AI system will initiate appropriate recovery actions, such as emergency landing procedures or activating backup systems, to minimize the potential damage or risk.

The recommendation & intervention engine 310, or a lightweight version thereof, can be fitted (or retrofitted) into a drone 102 as part of the Drone Data & AI/ML Engine 502, to provide recommendations and interventions based on fault detection performed by ML fault detection component 304, as informed by the CSFM risk prediction component 308.

The recommendation & intervention engine 310 uses inputs from the CSFM risk prediction component 308 combined with the in-flight detection of faults by the ML fault detection component 304 to generate recommended interventions to mitigate potential failures. For example, if a propeller-broken fault is detected with 90% probability, in some examples this is reported to the data environment 508 via the Master Data Management hub 504, and then a command to initiate a corresponding correction or mitigation measure is issued to the flight control software 534. In many cases, corrective measures are instructed by a human pilot, but automated correction or mitigation measures can also be implemented by flight control software 534 or the Drone Data & AI/ML Engine 502 itself depending on the implementation and on the severity of the fault.

That is, in some examples, it is ML models at the command center 312 that assess the safety status of the flight and predict impending failures with risk scores provided by a CSFM risk prediction component 308 located in the data environment 508. A recommendation & intervention engine 310, also included in the data environment 508, recommends a course of action to take for each type of failure, and automates an appropriate response. For example, if a probable failure is predicted due to thermal failure in one of the motors, then a corresponding remedial measure may for example be recommended that permits cooling of the motor, such as a decrease in the power or speed of that motor and an increase in the speed or power of other rotors to compensate.

Robotic Process Automation (RPA) is a software technology that can be used to build, deploy, and manage software robots that emulate human flight control actions, and that can interact with the mechanical, digital systems and software. In some examples, the drone 102 includes an RPA component to optionally automate the airframe and electrical propulsion system failure response actions recommended by the recommendation & intervention engine 310, such that a pilot's intervention is optional.

A fault detection master data structure is derived from a combination of standard structured and unstructured failure data formats such as Flight Summary Reports. These base data sets are combined with in-flight and on-ground (maintenance lab) data sets to create a comprehensive failure-influencing-variables data repository from which the various machine learning models learn continuously. This repository is further enriched by the loading of corresponding reference data sets that further explain the meaning and significance of the code sets found within the underlying historic aviation faults and failure data. In some examples, the present system includes an RPA component to optionally automate the airframe and electrical propulsion system failure response actions recommended by the Intervention engine.

In operation, each SUAS 100 is in communication with the data environment 508, via network(s) 112. These connections may or may not be available depending on the circumstances.

Each drone 102 is flown by a pilot via a ground control station 108. Each drone 102 monitors its operating conditions using its Drone Data & AI/ML Engine 502, which provides developing fault notifications and recommendations to the corresponding ground control station 108. If connectivity is available, relevant operational data is also transmitted to the data environment 508, which allows analysis performed by each Drone Data & AI/ML Engine 502 to be supplemented by analysis performed by more powerful and sophisticated aggregate data and prediction analysis models, such as AI/ML engines 522, hosted in the data environment 508. Flight logs and additional data logged for future use in the system are not typically transmitted while the drone 102 is in flight, but are typically stored aboard the drone 102 during flight and transferred via a data cable or wireless link to the ground control station 108 after the flight, which then uploads it to the data environment 508.

In the event of an imminent failure reported to or detected by the data environment 508, UAV maintenance 532 can automatically ship or order a replacement part to be sent to the SUAS customer or vendor, or alternatively a return merchandise authorization can automatically be generated and sent by UAV maintenance 532.

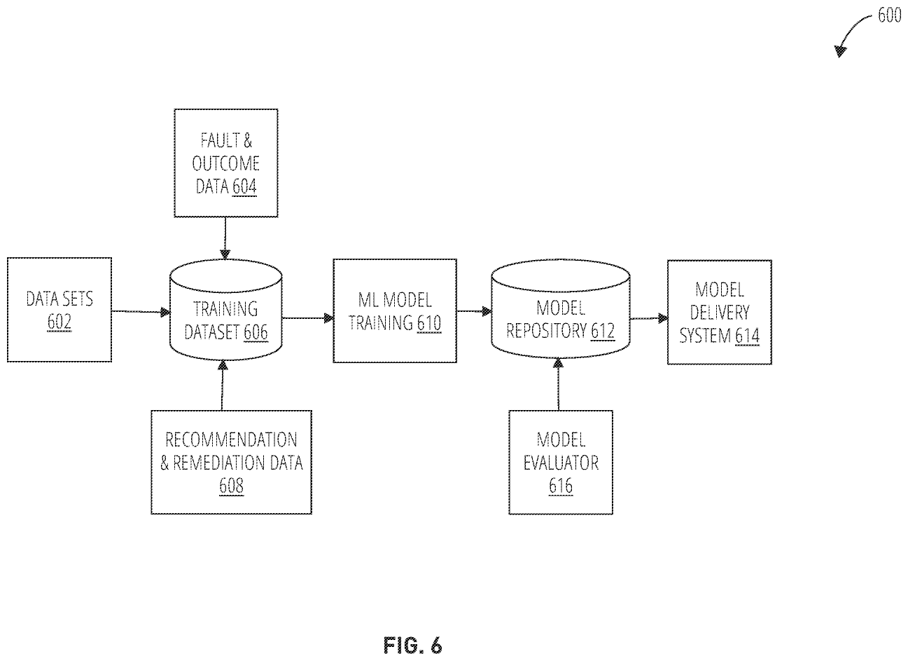

FIG. 6 is a schematic diagram illustrating an AI/ML training system architecture 600 according to some examples. The architecture 600 generates a training dataset 606 based on data sets 602 of sensor data, maintenance data, and other data as described above, as well as related fault & outcome data 604, with pre-defined recommendation & remediation data 608. The fault and outcome data for a particular data set specifies what happened under the conditions defined in the data (such as a thermal fault of a particular kind) as well as the outcome of the particular fault (such as complete motor failure within five minutes). The recommendation & remediation data 608 specifies the recommended action and/or remediation steps that need to be taken, for example that when a particular thermal fault is detected, the drone 102 must land immediately without attempting to return to its designated takeoff or landing location.

ML model training 610 trains ML models from the training dataset 606, to generate the various ML models of the ML ensemble 416 as discussed above, which are stored in a model repository 612. A model evaluator 616 can be run to test the accuracy of the generated models, using select data from the data sets 602 and/or similar data that has not been used to train the model under test. The model evaluator thus verifies whether and how well generated models actually work, and whether their detection of faults and associated recommendations can be trusted.

The model delivery system 614 provides a platform for delivering the correct version of a trained model to the correct drone 102 or to the command center 312 or data environment 508. For example, the model delivery system 614 includes a user interface that permits software engineers to update the ML models if needed, and a delivery system to transmit the model files reliably to manufacturing or retrofitting centers, or to a drone 102 in service via the data environment 508.

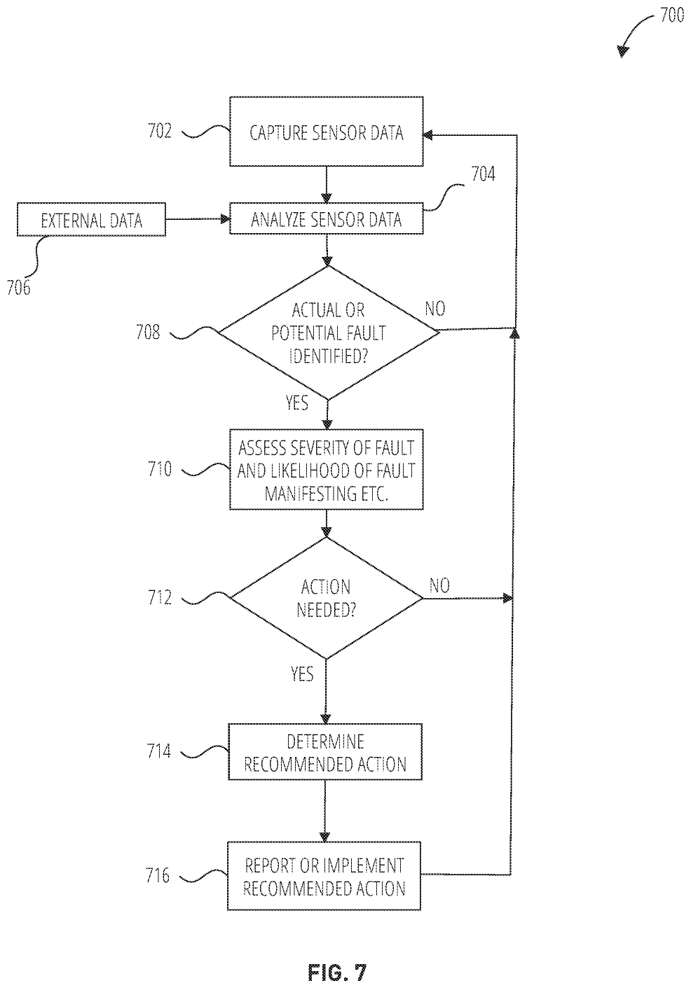

FIG. 7 is a flowchart 700 illustrating a method of implementing an airframe and electrical propulsion system failure prediction and mitigation system in an SUAS 100 according to some examples. For explanatory purposes, the operations of the flowchart 700 are described herein as occurring in serial, or linearly. However, multiple operations of the flowchart 700 may occur in parallel. In addition, the operations of the flowchart 700 need not be performed in the order shown and/or one or more blocks of the flowchart 700 need not be performed and/or can be replaced by other operations. Furthermore, while the operations in flowchart 700 are described with reference to the fault detection and mitigation process running on a drone 102, the associated functionality may alternative be provided as part of a distributed processing system including one or more servers as mentioned above.

The flowchart 700 begins at operation 702 with the capture of data from the relevant sensors (such as current sensors 418, temperature sensors 420, vibration sensors 422, microphones 424, image sensors 426, battery sensors 428, motion & position sensors 430) during operation of the drone, for example in flight, preflight or in maintenance or testing. Any external data used or required by the AI/ML components is provided in operation 706. The data is analyzed in operation 704 by one or more of the machine learning models, such as the ML ensemble 416.

In operation 708, if the ML ensemble 416 does not detect an actual or potential fault then the method returns to operation 702 and monitoring of the sensor data continues. If a fault or a potential fault is detected in operation 708, then the severity of the type of fault, the severity of the particular fault, the likelihood of it manifesting (if it has not already), and the likely time to manifestation are assessed by the CSFM risk prediction component 308.

If the recommendation & intervention engine 310 determines in operation 710 and operation 712 that action is not required, for example that the fault is of a minor type that will not affect the current flight, or the likelihood of the fault manifesting is small or distant in time, the method returns to operation 702 and proceeds from there. If the recommendation & intervention engine 310 determines in operation 710 and operation 712 that action is required, for example that the fault is of a major type that will affect the current flight and is likely to manifest, the method proceeds operation 714 where a recommended course of action is determined by the recommendation & intervention engine 310. The recommended action is then either implemented by the drone 102 (in the case of an automated system) or is reported, together with data on the potential fault that has been identified, to the ground control station 108 and to the command center 312 for further action in operation 716. In such a case, a pilot can choose to implement the recommended course of action or take some other action.

The method then returns to operation 702 for ongoing capture of live sensor data.

Associated with each of the operations in flowchart 700 is data capture and storage for subsequent use and analysis, for example to be used for post-flight analysis and for training or retraining of the models in the ML ensemble 416. Data captured would include sensor data, fault and potential fault identification, fault assessment results, recommended actions that were determined, how the recommended action was implemented (manually or automatically) and the responses and outcomes that occurred during the implementation of the recommended action(s).

Various examples are contemplated. Example 1 is a computer-implemented method of operating a Small Uncrewed Aircraft System (SUAS), the method comprising: capturing data during operation of the SUAS from a number of sensors of different types; performing analysis on the captured data using one or more Artificial Intelligence/Machine Learning (AI/ML) models that have been trained on data sets including historical SUAS data and SUAS system fault data, to predict or identify a potential SUAS failure mode; and when a potential failure mode is predicted or identified, providing a course of action for further operation of the SUAS based on a severity and predicted timing of the potential SUAS failure mode.

In Example 2, the subject matter of Example 1 includes, wherein the historical SUAS data comprises SUAS sensor data and flight logs associated with particular SUAS failure modes.

In Example 3, the subject matter of Example 2 includes, wherein the historical SUAS data comprises drone flight logs, battery charging and discharging logs, and maintenance logs.

In Example 4, the subject matter of Examples 2-3 includes, wherein the number of sensors comprise motor current and voltage sensors, thermal sensors, acoustic or vibration sensors and battery internal cell voltage sensors.

In Example 5, the subject matter of Examples 1-4 includes, wherein the number of sensors include image sensors, the one or more AI/ML models predicting or identifying a potential SUAS failure mode based on differences in images captured over time by the image sensors.

In Example 6, the subject matter of Examples 1-5 includes, wherein the number of sensors include position sensors, and the one or more AI/ML models predict or identify a potential SUAS failure mode based on data from the position sensors deviating from a flight plan.

In Example 7, the subject matter of Examples 1-6 includes, wherein the SUAS includes a drone, and the course of action is autonomous landing of the drone.

In Example 8, the subject matter of Examples 1-7 includes, wherein the SUAS comprises a Small Uncrewed Aircraft (drone) and the one or more AI/ML models comprise one or more AI/ML models located in the drone and one or more remote core AI/ML models accessible wirelessly.

In Example 9, the subject matter of Examples 1-8 includes, wherein the AI/ML models have been trained on simulated operational data generated by Generative AI, and pilot responses to the simulated operational data.

In Example 10, the subject matter of Examples 1-9 includes, wherein the performing of the analysis on the captured data comprises comparing a pilot flight pattern to a model flight pattern generated by Generative AI.

Example 11 is a Small Uncrewed Aircraft (drone) comprising: a plurality of electric motors; multiple sensors of different types to generate data relating to operation of the drone; and one or more data processors including instructions to cause the performance of operations comprising: capturing data during operation of the drone from the number of sensors of different types; performing analysis on the captured data using one or more Artificial Intelligence/Machine Learning (AI/ML) models that have been trained on data sets including historical drone data and drone system fault data, to predict or identify a potential drone failure mode; and when a potential failure mode is predicted or identified, providing a course of action for further operation of the drone based on a severity and predicted timing of the potential drone failure mode.

In Example 12, the subject matter of Example 11 includes, wherein the historical SUAS data comprises drone flight logs, battery charging and discharging logs, and maintenance logs.

In Example 13, the subject matter of Examples 11-12 includes, wherein the number of sensors include position sensors, and the one or more AI/ML models predict or identify a potential SUAS failure mode based on data from the position sensors deviating from a flight plan.

In Example 14, the subject matter of Examples 11-13 includes, wherein the AI/ML models have been trained on simulated operational data generated by Generative AI, and pilot responses to the simulated operational data.

In Example 15, the subject matter of Examples 11-14 includes, wherein the AI/ML models have been trained on simulated operational data generated by Generative AI, and pilot responses to the simulated operational data.

Example 16 is a non-transitory computer-readable storage medium, the computer-readable storage medium including instructions that when executed by a computer, cause the computer to perform operations for operating a Small Uncrewed Aircraft System (SUAS), the operations comprising: capturing data during operation of the SUAS from a number of sensors of different types; performing analysis on the captured data using one or more Artificial Intelligence/Machine Learning (AI/ML) models that have been trained on data sets including historical SUAS data and SUAS system fault data, to predict or identify a potential SUAS failure mode; and when a potential failure mode is predicted or identified, providing a course of action for further operation of the SUAS based on a severity and predicted timing of the potential SUAS failure mode.

In Example 17, the subject matter of Example 16 includes, wherein the historical SUAS data comprises drone flight logs, battery charging and discharging logs, and maintenance logs.

In Example 18, the subject matter of Examples 16-17 includes, wherein the number of sensors include position sensors, and the one or more AI/ML models predict or identify a potential SUAS failure mode based on data from the position sensors deviating from a flight plan.

In Example 19, the subject matter of Examples 16-18 includes, wherein the AI/ML models have been trained on simulated operational data generated by Generative AI, and pilot responses to the simulated operational data.

In Example 20, the subject matter of Examples 16-19 includes, wherein the AI/ML models have been trained on simulated operational data generated by Generative AI, and pilot responses to the simulated operational data.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20. Example 23 is a system to implement of any of Examples 1-20. Example 24 is a method to implement of any of Examples 1-20.

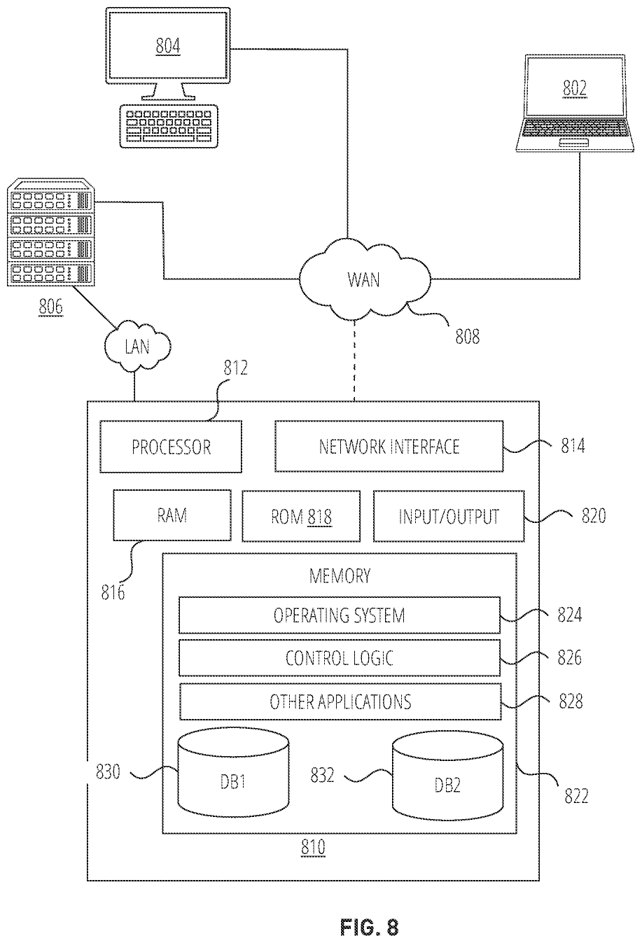

FIG. 8 illustrates one example of a system architecture and data processing device that may be used to implement one or more illustrative aspects described herein in a standalone and/or networked environment. Various network nodes, such as data server 810, web server 806, computer 804, and laptop 802 may be interconnected via a wide area network 808 (WAN), such as the internet. Other networks may also or alternatively be used, including private intranets, corporate networks. LANs, metropolitan area networks (MANs) wireless networks, personal networks (PANs), and the like. Network 808 is for illustration purposes and may be replaced with fewer or additional computer networks. A local area network (LAN) may have one or more of any known LAN topology and may use one or more of a variety of different protocols, such as ethernet. Devices, such as data server 810, web server 806, computer 804, laptop 802 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 810, web server 806, and client computer 804, laptop 802. Data server 810 provides overall access, control and administration of databases and control software for performing one or more illustrative aspects described herein. Data server 810 may be connected to web server 806 through which users interact with and obtain data as requested. Alternatively, data server 810 may act as a web server itself and be directly connected to the internet. Data server 810 may be connected to web server 806 through the network 808 (e.g., the internet), via direct or indirect connection, or via some other network. Users may interact with the data server 810 using remote computer 804, laptop 802, e.g., using a web browser to connect to the data server 810 via one or more externally exposed web sites hosted by web server 806. Client computer 804, laptop 802 may be used in concert with data server 810 to access data stored therein, or may be used for other purposes. For example, from client computer 804, a user may access web server 806 using an internet browser, as is known in the art, or by executing a software application that communicates with web server 806 and/or data server 810 over a computer network (such as the internet).

Servers and applications may be combined on the same physical machines, and retain separate virtual or logical addresses, or may reside on separate physical machines. FIG. 8 illustrates just one example of a network architecture that may be used, and those of skill in the art will appreciate that the specific network architecture and data processing devices used may vary, and are secondary to the functionality that they provide, as further described herein. For example, services provided by web server 806 and data server 810 may be combined on a single server.

Each component such as data server 810, web server 806, computer 804, laptop 802 may be any type of known computer, server, or data processing device. Data server 810, e.g., may include a processor 812 controlling overall operation of the data server 810. Data server 810 may further include RAM 816, ROM 818, network interface 814, input/output interfaces 820 (e.g., keyboard, mouse, display, printer, etc.), and memory 822. Input/output interfaces 820 may include a variety of interface units and drives for reading, writing, displaying, and/or printing data or files. Memory 822 may further store operating system software 824 for controlling overall operation of the data server 810, control logic 826 for instructing data server 810 to perform aspects described herein, and other application software 828 providing secondary, support, and/or other functionality which may or may not be used in conjunction with aspects described herein. The control logic may also be referred to herein as the data server software control logic 826. Functionality of the data server software may refer to operations or decisions made automatically based on rules coded into the control logic, made manually by a user providing input into the system, and/or a combination of automatic processing based on user input (e.g., queries, data updates, etc.).

Memory 822 may also store data used in performance of one or more aspects described herein, including a first database 832 and a second database 830. In some embodiments, the first database may include the second database (e.g., as a separate table, report, etc.). That is, the information can be stored in a single database, or separated into different logical, virtual, or physical databases, depending on system design. Web server 806, computer 804, laptop 802 may have similar or different architecture as described with respect to data server 810. Those of skill in the art will appreciate that the functionality of data server 810 (or web server 806, computer 804, laptop 802) as described herein may be spread across multiple data processing devices, for example, to distribute processing load across multiple computers, to segregate transactions based on geographic location, user access level, quality of service (QoS), etc.

One or more components may include or be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a non-transitory computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product.

Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as small talk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a component, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method of operating a Small Uncrewed Aircraft System (SUAS), the method comprising:
capturing data during operation of the SUAS from a number of sensors of different types;
performing analysis on the captured data using one or more Artificial Intelligence/Machine Learning (AI/ML) models that have been trained on data sets including historical SUAS data and SUAS system fault data, to predict or identify a potential SUAS failure mode; and
when a potential failure mode is predicted or identified, providing a course of action for further operation of the SUAS based on a severity and predicted timing of the potential SUAS failure mode.

2. The computer-implemented method of claim 1 wherein the historical SUAS data comprises SUAS sensor data and flight logs associated with particular SUAS failure modes.

3. The computer-implemented method of claim 2, wherein the historical SUAS data comprises drone flight logs, battery charging and discharging logs, and maintenance logs.

4. The computer-implemented method of claim 2, wherein the number of sensors comprise motor current and voltage sensors, thermal sensors, acoustic or vibration sensors and battery internal cell voltage sensors.

5. The computer-implemented method of claim 1, wherein the number of sensors include image sensors, the one or more AI/ML models predicting or identifying a potential SUAS failure mode based on differences in images captured over time by the image sensors.

6. The computer-implemented method of claim 1, wherein the number of sensors include position sensors, and the one or more AI/ML models predict or identify a potential SUAS failure mode based on data from the position sensors deviating from a flight plan.

7. The computer-implemented method of claim 1, wherein the SUAS includes a drone, and the course of action is autonomous landing of the drone.

8. The computer-implemented method of claim 1, wherein the SUAS comprises a Small Uncrewed Aircraft (drone) and the one or more AI/ML models comprise one or more AI/ML models located in the drone and one or more remote core AI/ML models accessible wirelessly.

9. The computer-implemented method of claim 1, wherein the AI/ML models have been trained on simulated operational data generated by Generative AI, and pilot responses to the simulated operational data.

10. The computer-implemented method of claim 1, wherein the performing of the analysis on the captured data comprises comparing a pilot flight pattern to a model flight pattern generated by Generative AL.

11. A Small Uncrewed Aircraft (drone) comprising:
a plurality of electric motors;
multiple sensors of different types to generate data relating to operation of the drone; and
one or more data processors including instructions to cause the performance of operations comprising:
capturing data during operation of the drone from a number of sensors of different types;
performing analysis on the captured data using one or more Artificial Intelligence/Machine Learning (AI/ML) models that have been trained on data sets including historical drone data and drone system fault data, to predict or identify a potential drone failure mode; and
when a potential failure mode is predicted or identified, providing a course of action for further operation of the drone based on a severity and predicted timing of the potential drone failure mode.

12. The drone of claim 11, wherein the historical drone data comprises drone flight logs, battery charging and discharging logs, and maintenance logs.

13. The drone of claim 11, wherein the number of sensors include position sensors, and the one or more AI/ML models predict or identify a potential drone failure mode based on data from the position sensors deviating from a flight plan.

14. The drone of claim 11, wherein the AI/ML models have been trained on simulated operational data generated by Generative AI, and pilot responses to the simulated operational data.

15. The drone of claim 11, wherein the AI/ML models have been trained on simulated operational data generated by Generative AI, and pilot responses to the simulated operational data.

16. A non-transitory computer-readable storage medium, the computer-readable storage medium including instructions that when executed by a computer, cause the computer to perform operations for operating a Small Uncrewed Aircraft System (SUAS), the operations comprising:
capturing data during operation of the SUAS from a number of sensors of different types;
performing analysis on the captured data using one or more Artificial Intelligence/Machine Learning (AI/ML) models that have been trained on data sets including historical SUAS data and SUAS system fault data, to predict or identify a potential SUAS failure mode; and
when a potential failure mode is predicted or identified, providing a course of action for further operation of the SUAS based on a severity and predicted timing of the potential SUAS failure mode.

17. The non-transitory computer-readable storage medium of claim 16, wherein the historical SUAS data comprises drone flight logs, battery charging and discharging logs, and maintenance logs.

18. The non-transitory computer-readable storage medium of claim 16, wherein the number of sensors include position sensors, and the one or more AI/ML models predict or identify, a potential SUAS failure mode based on data from the position sensors deviating from a flight plan.

19. The non-transitory computer-readable storage medium of claim 16, wherein the AI/ML models have been trained on simulated operational data generated by Generative AI, and pilot responses to the simulated operational data.

20. The non-transitory computer-readable storage medium of claim 16, wherein the AI/ML models have been trained on simulated operational data generated by Generative AI, and pilot responses to the simulated operational data.
